(19) United States
(12) Patent Application Publication
(10) Pub. No.: US 2013/0204641 A1
(43) Pub. Date: Aug. 8, 2013

(54) Social Authentication for Accessing Health Records

(71) Applicant: Shahid N. Shah, Silver Spring, MD (US)

(72) Inventor: Shahid N. Shah, Silver Spring, MD (US)

(73) Assignee: Netspactive Communications LLC, Silver Spring, MD (US)

(21) Appl. No.: 13/756,433

(22) Filed: Jan. 31, 2013

Related U.S. Application Data
(60) Provisional application No. 61/594,216, filed on Feb. 2, 2012.

(51) Int. Cl. G06Q 50/24

(52) U.S. Cl. CPC G06Q 50/24
USPC 705/3

(57) ABSTRACT

A system for facilitating access to a Social Heath Record Database (SHRDB) through a social networking platform over a communications network. The system includes an information management platform including one or more database server and one or more social network server configured to implement information storage and retrieval functions within the SHRDB. The system further includes the SHRDB communicatively coupled to the information management platform. The system further includes a social networking engine communicatively coupled to the SHRDB through the social network server to allow interfacing of the SHRDB with the social networking service/platform. The system further includes a programmatic web interface configured as a single sign-on scheme to allow access of one or more repositories of the SHRDB.

### CROSS-REFERENCE TO RELATED APPLICATIONS

This application claims the benefit of U.S. Provisional Application No. 61/594,216, filed on Feb. 2, 2012, the complete disclosure of which, in its entirety, is hereby incorporated by reference.

### BACKGROUND

1. Technical Field

The embodiments herein generally relate to data management and access, more particularly, to healthcare data management and access systems and methods.

2. Description of the Related Art

Hospitals, caretakers, nursing centers or homes, medical offices, medical centers, or other sources of medical care and entities generally keep medical and demographic or other such records of their patients. These records may include a variety of information such as demographic information of their patients, medical history, diagnostic and pathology reports of their patients, medical reports or prescriptions, or other such information. This information can be used for a variety of purposes by these sources of medical care. A few examples of them are, without limitations, tracking of the patients and their records, billing, historical assessments, integrating with medical devices, remote care, future care taking, telemedicine, proper ongoing medical or health assessment or treatment, or any other similar purpose.

One way to collate and store the medical data is with the use of an electronic health record data bank (EHRDB). These records from various entities can be electronically maintained such as by the electronic health record data bank (EHRDB) in a central system accessible by the entities. The EHRDB may store medical data of the entities and retrieve the data of the respective entities as and when requested by them.

There is a need for an improved system and a method that provides a facility to interact with the EHRDB.

### SUMMARY

An embodiment herein provides a system for facilitating access to a Social Heath Record Database (SHRDB) through a social networking service or platform over a communications network. The system includes an information management platform including one or more database server and one or more social network server configured to implement information storage and retrieval functions within the SHRDB. The system further includes the SHRDB communicatively coupled to the information management platform. The SHRDB includes or is coupled to a processing component capable of executing instructions to process medical records over the communications network. The SHRDB further includes one or more of a Social Health Record (SHR) repository, Health Information Exchange (HIE) repository, and a Virtual Medical Records (VMR) repository to store the medical records. The system further includes a social networking engine communicatively coupled to the SHRDB through the social network server to allow interfacing of the SHRDB with the social networking service/platform. The system further includes a programmatic web interface configured as a single sign-on scheme to allow access of the one or more of the SHR repository, HIE repository, and the VMR repository of the SHRDB from one or more distinct social networking platforms using a credential associated with any of the one or more of the distinct social networking platforms. The one or more of the SHR repository, HIE repository, and the VMR repository are each provided with a distinct application configured to be initiated upon access of the respective of the SHR repository, HIE repository, and a VMR repository allowing retrieval of medical records associated with the SHR repository, HIE repository, and the VMR repository.

Another embodiment provides a method for accessing a Social Health Record Data Bank (SHRDB) using a social networking platform. The method includes receiving a request from a user for accessing the SHRDB through a social networking platform. The method further includes authenticating a single sign-on credential of the user associated with the social networking platform. The method further includes retrieving medical records from the SHRDB as requested by the user. The retrieving of the medical records include at least one of sharing of the medical records either partially or fully to the user and allowing viewing of the medical records at least partially by the user.

Another embodiment provides a program storage device readable by computer, and comprising a program of instructions executable by the computer to perform a method for accessing a social health record data bank (SHRDB) by a user. The method includes receiving a request from a user for accessing the SHRDB through a social networking platform. The method further includes authenticating a single sign-on credential of the user associated with the social networking platform. The method further includes retrieving medical records from the SHRDB as requested by the user. The retrieving of the medical records include at least one of sharing of the medical records either partially or fully to the user and allowing viewing of the medical records at least partially by the user.

### BRIEF DESCRIPTION OF THE FIGURES

The features of the disclosed embodiments may become apparent from the following detailed description taken in conjunction with the accompanying drawings showing illustrative embodiments, in which:

FIG. 1 illustrates generally, but not by the way of limitation, among other things, an example of a network communication system supporting a social networking service and a single sign-on scheme to access Social Heath Record Database (SHRDB), in accordance with various embodiments;

FIG. 2 is a block diagram illustrating generally, but not by the way of limitation, among other things, an example of an operating environment in which various embodiments operate;

FIG. 3 illustrates generally, but not by the way of limitation, an example of a single sign-on authentication scheme that may be used to access the system such as those illustrated in FIG. 1 and FIG. 2;

FIG. 4 illustrates a method of accessing a plurality of data sources using a single sign-on authentication scheme; and

FIG. 5 illustrates generally, but not by the way of limitation, a computer system that may be used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

A method or a system is provided for accessing Social Health Records (SHR) via a single sign-on scheme provided by a social networking service. The social networking service allows access to the SHR data related to one or more users of a Social Health Record Data Bank (SHRDB). The method or the system comprises, receiving a request including a single sign-on credential via a single sign-on scheme facilitated by the social networking service. The single sign-on credential qualifies a qualification parameter stored in the SHRDB for accessing the SHR data associated with one or more users.

In general, various embodiments provide access to an SHR application, which further allows access to the SHRDB including SHR data associated with the one or more users via the single sign-on scheme of the social networking service. The SHR application can implement one or more electronic security technologies providing the one or more users to view, manage, or control SHR data related to different sources of the SHRDB via the single sign-on scheme of the social networking service. The detailed description about these sources is described in later paragraphs of the document.

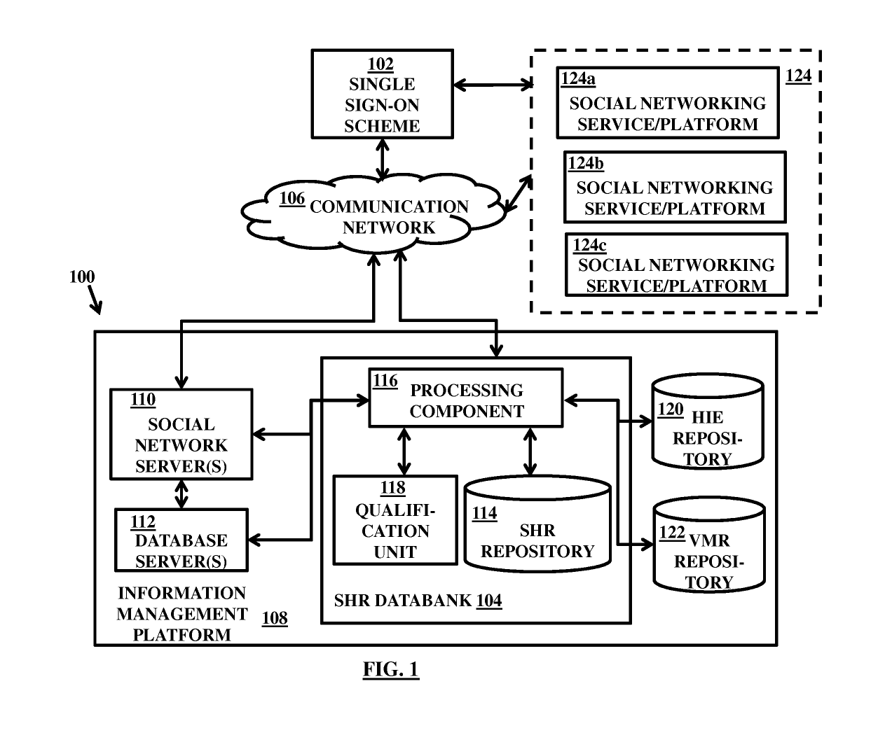

FIG. 1 illustrates generally, but not by the way of limitation, among other things, an example of a system 100 supporting one or more distinct social networking services 124 and a single sign-on scheme 102 to access a Social Heath Record Database (SHRDB) 104 including Social Heath Record (SHR) data associated with one or more users. The system 100 facilitates access to the SHRDB 104 through the social networking service or platform 124 over a communications network 106. The system 100 allows the social networking service 124 to provide the single sign-on scheme 102 to the one or more users for accessing the SHRDB 104. The single sign-on scheme 102 may be implemented, for example, as a software application running on a personal computer. The system 100 provides the single sign-on scheme 102 to the one or more users. The one or more users described herein may be a web user executing instructions or tasks on a user machine such as a personal computer, laptop, portable device, mobile phone, tablets or any other machine. In examples, the web user described herein may be a web browser, or other types of web services that may be employed. The one or more users may be a patient, a doctor, a physician, a healthcare unit, a hospital, a nursing home, a healthcare professional or any other entity or a combination thereof.

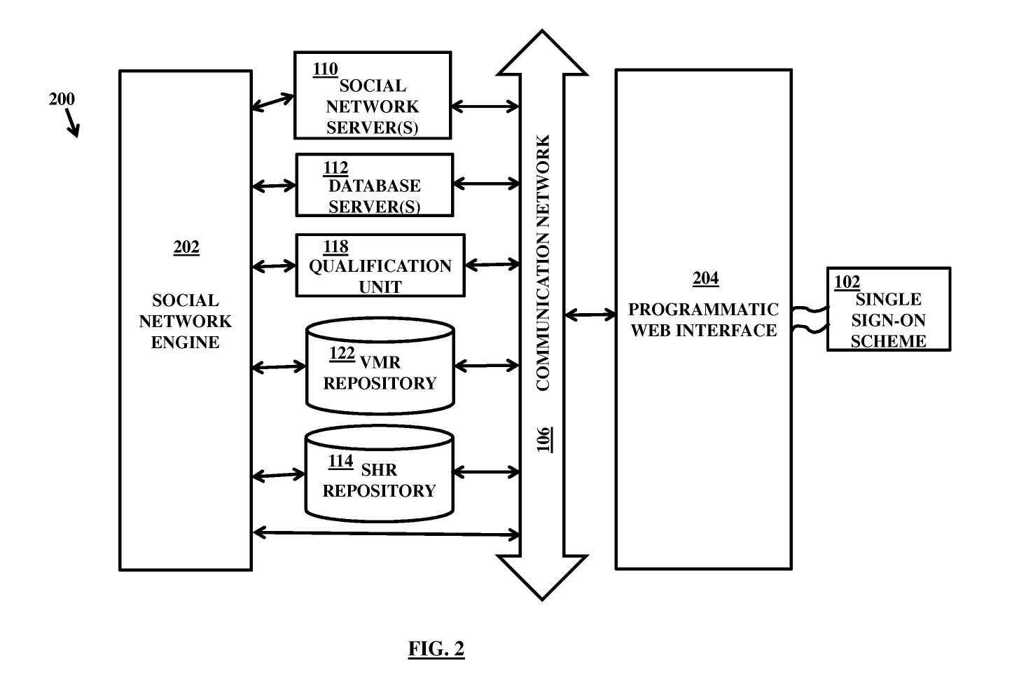

The system 100 provides or includes an information management platform 108, which implements information storage and retrieval functions and services for the one or more users accessing the information management platform 108 or the SHRDB 104. The information management platform 106 includes a social network server 110 to provide a programmatic web interface (shown in FIG. 2). The programmatic web interface may be configured as the single sign-on scheme 102 to allow access of the SHRDB 104 or one or more portions of the SHRDB 104. In an embodiment, the programmatic web interface is configured as the single sign-on scheme 102 to allow access of the one or more portions of the SHRDB 104 from one or more distinct social networking platforms 124 using a credential associated with any of the one or more of the distinct social networking platforms 124. The programmatic web interface facilitates the one or more users to provide the single sign-on access to the SHRDB 104. The information management platform 108 may further include or is coupled to one or more database servers 112. The social network server 110 is shown to be coupled to the one or more database servers 112 that facilitate access to social data associated with one or more users in the communication network 106. The SHRDB 104 may be communicatively coupled to the information management platform 108.

The SHRDB 104, described herein, may be centralized or decentralized. The SHRDB 104 may store SHR data related to the one or more users in an SHR repository 114. The SHRDB 104 may communicate with different servers and repositories such as the social network server 110, a database server 112, Health Information Exchange (HIE) repository 120, Virtual Medical Records (VMR) repository 122 or any other server or repository to form a social cloud among the one or more users. The SHR repository 114 can store a plurality of heath care records including data or information related to the one or more users. The data can be organized in a way that facilitates local or remote information retrieval in the communication network 106 via a processing component 116. In some embodiments, the processing component 116 may comprise, but is not limited to, a microprocessor, a microcontroller, or equivalent. The processing component 116 may be capable of executing instructions to process data over the communications network 106. The data corresponding to an individual user may or may not have been derived from medical testing or treatment (e.g., the data may have been derived from a research organization trial in which the individual voluntarily participated or data may have been derived from insurance services or any other source).

More generally, SHRDB 104 may also include data related to different sources such as doctor's visits, lab tests, hospital stays, clinical trials, patient problems, patients health information, patient habits, patient medical history, patient appointments, patient medical insurance, patient medical bills status, or any other information. The SHRDB 104 may coupled to other data sources such as the HIE repository 120 and the VMR repository 122. The HIE repository 120 may include electronic healthcare information related to a region, community, or hospital system. The HIE repository 120 may exchange the healthcare information among other health information exchange systems such that the HIE repository 120 may allow safe access to the healthcare information by one or more users via SHR systems such as SHRDB 104, VMR repository 122, or any other SHR system. The VMR repository 122 may store data related to the medical information related to the one or more users. The virtual medical records described herein may be simplified, standardized health record data designed to support interfacing to the SHRDB 104 such that the present system 100 can allow the one or more users to access the health care data from different sources such as the SHRDB 104, the HIE repository 120, the VMR repository 122, or any other sources via the single sign-on scheme 102.

In some embodiments, the programmatic web interface as discussed above may be configured as the single sign-on scheme 102 to allow access of the one or more of the SHR repository 114, HIE repository 120, and the VMR repository 122 of the SHRDB 104 from one or more distinct social networking platforms 124 using a credential associated with any of the one or more of the distinct social networking platforms 124. The one or more of the SHR repository 114, HIE repository 120, and the VMR repository 122 may each be provided with a distinct application configured to be initiated upon access of the respective of the SHR repository 114, HIE repository 120, and VMR repository 122 allowing retrieval of medical records associated with the SHR repository 114, HIE repository 120, and the VMR repository 122.

In some embodiments, the single sign-on scheme 102 provides a single authentication mechanism across various data repositories and systems as discussed above instead on one single system or repository. Generally, patient medical records may be stored in more than one systems or repositories. The medical records may be federated across the various repositories. Therefore, the single sign-on scheme 102 provides a federated social authentication mechanism.

The SHRDB 104 may include or be coupled to a qualification unit 118. The qualification unit 118 is capable of storing the one or more users' credential such as a username, password, or other data. The qualification unit 118 may also store one or more policies or rules associated with the one or more users, which may restrict access to portions of the SHR application or other sources. The SHRDB 104 allows the social network server 110 and database server 112 to interact with the qualification unit 118 to provide access to the SHR data related to the one or more users. The qualification unit 118 provides the one or more users qualification testing techniques or applications, which are used to identify the one or more users to access SHRDB 104 in a social network such that a social cloud may be organized among the one or more users. The SHRDB 104 may also interact with the database server 112 and SHR repository 114 to store and retrieve data related thereto. The qualification unit 118 may operate on information received from the single sign-on scheme 102 of the social network service. The social network service described herein may be, but is not limited to, Facebook™, Twitter™, Linkedln™, Orkut™ or any other social network service. Alternatively, the qualification unit 118 may also operate on information received from the SHR application allowing access to the SHRDB 104. The qualification unit 118 may authenticate the access to SHRDB 104 based on the general username and the password and access levels associated with the roles of the one or more users via the SHR application. In examples, the information received from the SHR application may be for example, but not limited to, general user credentials such as a username and password combination, user Google™ ID and password combination, user Amazon™ ID and password combination, or the like.

In some embodiments, the SHRDB 104 may also be referred to as an Electronic Health Record Database (EHRDB).

In accordance with some embodiments, authentication may be enabled through a fast and automated authentication scheme in which mobile phone numbers, IP addresses or any other specific details for the one or more users that may be pre-stored with the SHRDB 104 may be compared with the details of the one or more users during access. Then, upon comparison and confirmation, authentication may be performed accordingly. For example, if the mobile phone number used for accessing the SHRDB 104 is matched with the pre-stored number, the user may be automatically allowed to access the SHRDB 104 and without necessarily providing the details for confirmation again.

In an embodiment, the term single sign-on scheme 102 herein means that a user provides a single unique identifier (ID) and password combination (also referred to as credential information or login details or login credential) to gain access to one or multiple sources of the SHRDB 104 over the communication network 106 such as the Internet. In an embodiment, the term single sign-on scheme 102 is defined such that a user may provide any of several unique identifiers (IDs) and password combinations associated with several distinct social networking services 124 respectively to gain access to one or multiple services of the SHRDB 104.

In an example, the single sign-on scheme 102 corresponding to a user may include a first credential associated with a first social networking platform 124a, a second credential associated with a second social networking platform 124b, and a third credential associated with a third social networking platform 124c such that the user is associated with each of the first, second, and third social networking services or platforms 124a, 124b, and 124c. The user is allowed to access the one or more of the SHR repository 114, HIE repository 120, VMR repository 122 using any one of the first credential, second credential, and third credential from any of the first social networking platform, second social networking platform, and the third social networking platform 124a, 124b, and 124c. In another example, the single sign-on scheme 102 corresponding to a user is defined to associate a plurality of repositories of the SHRDB 104 with a plurality of social networking platforms 124 associated with the user such that the single sign-on scheme 102 includes a first credential associated with a first social networking platform 124a of the user, a second credential associated with a second social networking platform 124b of the user, and a third credential associated with a third social networking platform 124c of the user. The user is allowed to access the SHR repository 114 using the first credential from the first social networking platform 124a, HIE repository 120 using the second credential from the second social networking platform 124b, and the VMR repository 122 using the third credential from the third social networking platform 124c.

In another example, the single sign-on scheme 102 corresponding to a user is defined to associate a plurality of repositories of the SHRDB 104 with a plurality of social networking platforms 124 associated with the user such that the single sign-on scheme 102 includes a first credential associated with a first social networking platform 124a of the user, a second credential associated with a second social networking platform 124b of the user, and a third credential associated with a third social networking platform 124c of the user. The user may be allowed to access the SHR repository 114 using the first credential from any of the first, second and third social networking platform 124, HIE repository 120 using the second credential from any of the first, second, and third social networking platform 124, and the VMR repository 122 using the third credential from any of the first, second, and third social networking platform 124.

In an example, the single sign-on scheme 102 corresponding to a user is defined to associate a plurality of repositories of the SHRDB 104 with a plurality of social networking platforms 124 associated with the user such that the single sign-on scheme 102 includes a first credential associated with a first social networking platform 124a of the user, a second credential associated with a second social networking platform 124b of the user, and a third credential associated with a third social networking platform 124c of the user. The user is allowed to access the SHR repository 114 using the first, or second, or third credential from the first social networking platform 124a, HIE repository 120 using any of the first, second and third credential from the second social networking platform 124b, and the VMR repository 122 using any of the first, second, and third credential from the third social networking platform 124c.

In an example, the single sign-on scheme 102 corresponding to a user is defined to associate a plurality of repositories of the SHRDB 104 with a plurality of social networking platforms 124 associated with the user. The plurality of repositories includes the SHR repository 114, HIE repository 120, and the VMR repository 122 and the like which are configured as virtual partitions, in an embodiment, within the SHRDB 104 such that the single sign-on credential associated with the user is mapped by the social network server 110 or the information management platform 108 to allow access to the respective virtual partitions of the SHRDB 104. In an example, the single sign-on scheme 102 corresponding to the user may include a first credential associated with a first social networking platform 124a, a second credential associated with a second social networking platform 124b, and a third credential associated with a third social networking platform 124c such that the user is allowed to access the one or more of the virtual partitions-based repositories using one of the first credential, second credential, and third credential from any of the first social networking platform 124a, second networking platform 124b, and the third networking platform 124c or directly from a dedicated interface corresponding to the one or more virtual partitions. The dedicated interface may be any interface that supports specific portions of the SHRDB 104. In an example, a virtual layer may be deployed to allocate storage resources across the virtual partitions of the plurality of repositories for storage of the medical records corresponding to the user.

In an example, the single sign-on scheme 102 is configured as a multi-domain single sign-on scheme such that a user credential associated with any of a plurality of distinct-web-domain-based social networking platform such as 124a and 124b enables access to the SHRDB 104.

In an example, the social networking platform 124a may include a web interface including a tab such that the single sign-on scheme 102 may be triggered by activating an application through the tab manually. For example, the user when presses the tab may activate the application causing access to the SHRDB 104 or any of its portions through the single sign-on scheme 102. In another embodiment, the social networking platform 124a may include a web interface without any physical tab such that the single sign-on scheme 102 may be triggered automatically to activate an application as soon as the social networking platform 124a is accessed by the user.

It must be appreciated that the terms “social networking platform” and “social networking service” are used interchangeably without any limitations.

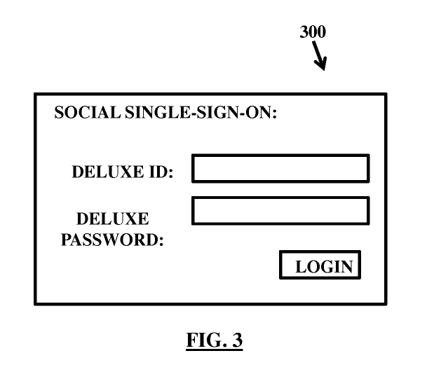

FIG. 2, with reference to FIG. 1, is a block diagram that illustrates generally, but not by the way of limitation, among other things, an example of an operating environment 200 in which various embodiments operate. The environment 200 includes a social network engine 202, which may be controlled by the social network server 110 to process the one or more user's data or request. The social networking engine 202 is communicatively coupled to the SHRDB 104 through the social network server 110 to allow interfacing of the SHRDB 104 with the social networking service or platform 124. The social network server 110 may provide a programmatic web interface 204 to the one or more users via the communication network 106. In examples, the programmatic web interface 204 is a single sign-on interface displayed to the one or more users to access the SHRDB 104 as shown in FIG. 3. The database server 112 may maintain social data related to the one or more users and integrate the social data with the social network server 110. The database server 112 may also store information related to an authenticated user and associated application to provide access to the SHRDB 104. The database server 112 may provide access to the stored applications based on the single sign-on credential provided by the user via the single sign-on scheme 102. In an example, the application described herein may be the SHR application.

The qualification unit 118 further maintains qualification parameters associated with the one or more users of the SHRDB 104. The qualification parameters may include the user credential information to access the social health care application via the single sign-on scheme 102 of the social network service 124 such that the one or more users can access, manage, or control the healthcare information associated with various sources such as the SHRDB 104, the HIE repository 120, the VMR repository 122, or any other sources via the single sign-on scheme 102. The qualification parameters may also include one or more users' role and policy information that may be used by the qualification unit 118 to qualify the one or more users to access the SHRDB 104. In examples, the qualification unit 118 may interact with the social network engine 202 to automatically test the credential provided by the single sign-on scheme 102, in accordance with the stored qualification parameters by the qualification unit 118, such that the user can access the SHRDB 104 via the social network service. The access to the SHRDB 104 by the social network engine 202 may be controlled by the qualification unit 118. The qualification unit 118 may use stored policies and rules to provide user specific access to the SHR data via the social network service.

In examples, the qualification unit 118 may provide an access control mechanism for qualifying the one or more users to access the SHRDB 104. The access control mechanism may allow the qualification unit 118 to send a request to the SHRDB 104 to allow the one or more users to access the SHR data associated with various sources such as the SHRDB 104, the HIE repository 120, the VMR repository 122, or any other sources, in accordance with the qualifying parameters and single sign-on credential received by the single sign-on scheme 202 of the social network service. As a result, a user qualified by the qualification unit 118 may be allowed to access the SHRDB 104 and associated SHR data of the one or more users. The qualification unit 118 may then allow the social network engine 202 to interact with the SHR repository 114, VMR repository 122, or HIE repository 120 to provide access to the SHR data to the one or more qualified users. The qualification unit 118 may develop additional Application Programming Interfaces (APIs), which may allow batch uploading of data for qualification processing associated with the one or more users.

FIG. 3, with reference to FIGS. 1 and 2, illustrates generally, but not by the way of limitation, an example of the single sign-on scheme 102 that may be used to access the system 100 such as illustrated in FIG. 1 and FIG. 2. The one or more users may log into the system 100 by supplying the single sign-on credential such as deluxe unique identifier (ID) and deluxe password. The term deluxe described herein means that the user provides a single unique ID and password combination to the single sign-on scheme 102 to gain access to one or multiple sources of the SHRDB 104, the HIE repository 120, the VMR repository 122, or any other source via the social network service over the communication network 106. Once the user is logged into system 100, the single sign-on scheme 102 may present the one or more users with the SHR data associated with the one or more users to access the SHRDB 104, in accordance with the single sign-on credential associated with the one or more users. For example, the single sign-on scheme 102 may present an SHR application providing the SHR data associated with the one or more users. The SHR application may be customized to provide access to different portions of the one or multiple sources associated with the one or more users that can be automatically accessed using the deluxe password and unique ID stored within system 100.

A method may also be provided for using the system 100 to access the SHRDB 104, in accordance with some embodiments. The method may allow the one or more users to provide the single sign-on credential to use the SHRDB 104 via the social network service 124.

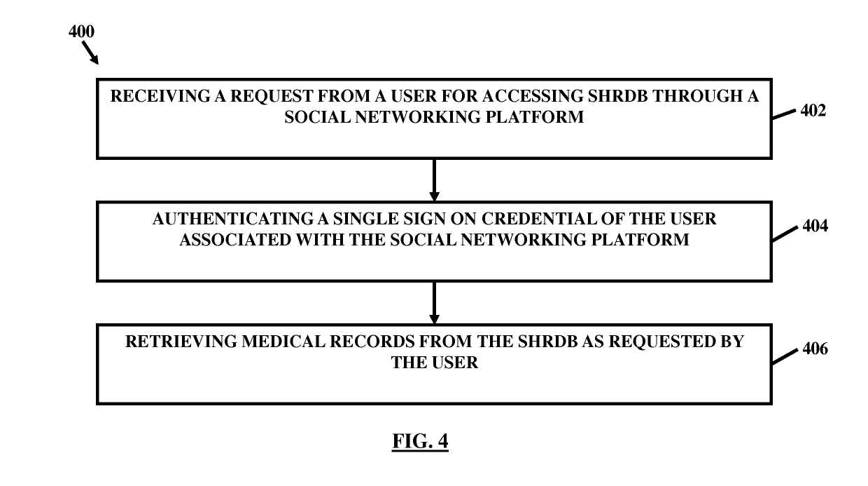

FIG. 4, with reference to FIGS. 1 through 3, illustrates a method of accessing a plurality of data sources associated with the SHRDB 104 using a single sign-on authentication scheme. The single sign-on scheme can be any of the single sign-on schemes 102 as discussed above in the form of various examples and embodiments.

At step 402, the method includes receiving a request from a user for accessing the SHRDB 104 through the social networking platform 124. The method further includes authenticating a single sign-on credential of the user associated with the social networking platform 124 at step 404. The credential associated for single sign-on has been discussed above in the form of several examples and embodiments. The method further includes retrieving medical records from the SHRDB 104 or one or more portions of the SHRDB 104 as requested by the user at step 406. The method of retrieving of the medical records may include at least one of sharing of the medical records either partially or fully to the user and allowing viewing of the medical records at least partially by the user. In an embodiment, the social networking platform 124 is a first social networking platform such as 124a, and the credential is a first credential associated with the first social networking platform 124a. The method may further include receiving a second request from the user for accessing the SHRDB 104 using a second credential through a second social networking platform 124b. In an embodiment at least one combination of (1) the first credential and the second credential (2) the first social networking platform 124a and the second social networking platform 124b, is different. For example, in case of (1), the user may access the portions of the SHRDB 104 using different credentials through the single sign-on scheme 102. In case of (2), the user may access various portions of the SHRDB 104 using various distinct social networking platforms such as 124a and 124b with the use of the single sign-on feature 102. In an embodiment, the single sign-on scheme 102 allows access of the SHRDB 104 by the user automatically upon accessing either of the first social networking platform 124a using the first credential or the second social networking platform 124b using the second credential.

The above description is mainly focused toward a network communication system supporting a social networking service. However, in accordance with some other embodiments, any other common online entity other than the social networking service may also be supported.

The embodiments herein may be embodied as a computer program product configured to include a pre-configured set of instructions, which when performed, can result in actions as stated in conjunction with the method 400 and described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

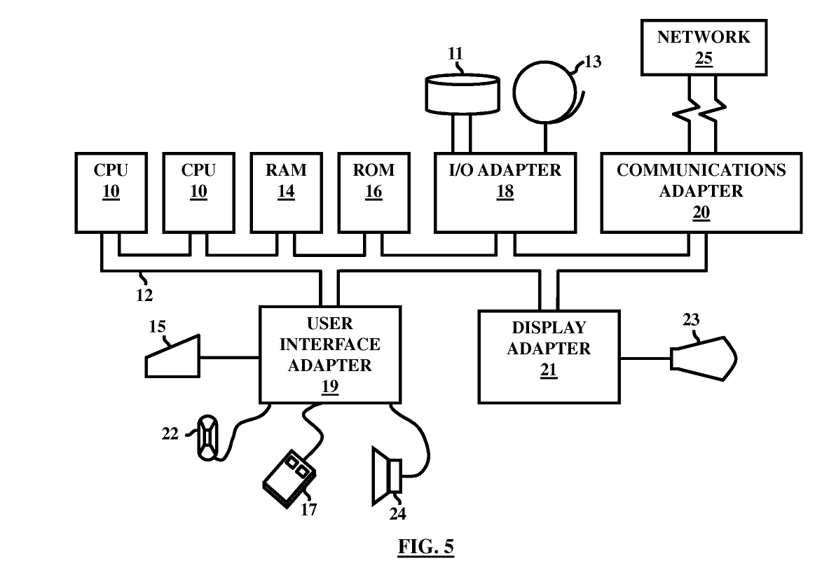

A representative hardware environment for practicing the embodiments herein is depicted in FIG. 5, with reference to FIGS. 1 through 4. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for facilitating access to a Social Heath Record Database (SHRDB) through a social networking service or platform over a communications network, said system comprising:
an information management platform including one or more database server and one or more social network server configured to implement information storage and retrieval functions within said SHRDB;
said SHRDB communicatively coupled to said information management platform, wherein said SHRDB is coupled to:
a processing component for executing instructions to process medical records over said communications network;
one or more of a Social Health Record (SHR) repository, Health Information Exchange (HIE) repository, and a Virtual Medical Records (VMR) repository to store said medical records;
a social networking engine communicatively coupled to said SHRDB through said social network server to allow interfacing of said SHRDB with said social networking service;
a programmatic web interface configured as a single sign-on scheme to allow access of said one or more of said SHR repository, HIE repository, and said VMR repository of said SHRDB from one or more distinct social networking platforms using a credential associated with any of said one or more of said distinct social networking platforms, wherein said one or more of said SHR repository, HIE repository, and said VMR repository are each provided with a distinct application configured to be initiated upon access of said respective of said SHR repository, HIE repository, and a VMR repository allowing retrieval of medical records associated with said SHR repository, HIE repository, and said VMR repository.

2. The system of claim 1, wherein said single sign-on scheme corresponding to a user includes a first credential associated with a first social networking platform, a second credential associated with a second social networking platform, and a third credential associated with a third social networking platform, wherein said user is allowed to access said one or more of said SHR repository, HIE repository, VMR repository using one of said first credential, second credential, and third credential from any of said first social networking platform, second networking platform, and said third networking platform.

3. The system of claim 1, wherein said single sign-on scheme corresponding to a user is defined to associate a plurality of repositories of said SHRDB with a plurality of social networking platforms associated with said user such that said single sign-on scheme includes a first credential associated with a first social networking platform of said user, a second credential associated with a second social networking platform of said user, and a third credential associated with a third social networking platform of said user, wherein said user is allowed to access said SHR repository using said first credential from said first social networking platform, HIE repository using said second credential from said second social networking platform, and said VMR repository using said third credential from said third social networking platform.

4. The system of claim 1, wherein said single sign-on scheme corresponding to a user is defined to associate a plurality of repositories of said SHRDB with a plurality of social networking platforms associated with said user such that said single sign-on scheme includes a first credential associated with a first social networking platform of said user, a second credential associated with a second social networking platform of said user, and a third credential associated with a third social networking platform of said user, wherein said user is allowed to access said SHR repository using said first credential from any of said first, second and third social networking platform, HIE repository using said second credential from any of said first, second, and third social networking platform, and said VMR repository using said third credential from any of said first, second, and third social networking platform.

5. The system of claim 1, wherein said single sign-on scheme corresponding to a user is defined to associate a plurality of repositories of said SHRDB with a plurality of social networking platforms associated with said user such that said single sign-on scheme includes a first credential associated with a first social networking platform of said user, a second credential associated with a second social networking platform of said user, and a third credential associated with a third social networking platform of said user, wherein said user is allowed to access said SHR repository using said first, or second, or third credential from said first social networking platform, HIE repository using any of said first, second and third credential from said second social networking platform, and said VMR repository using any of said first, second, and third credential from said third social networking platform.

6. The system of claim 1, wherein said single sign-on scheme corresponding to a user is defined to associate a plurality of repositories of said SHRDB with a plurality of social networking platforms associated with said user, said plurality of repositories including said SHR repository, HIE repository, and said VMR repository configured as virtual partitions within said SHRDB such that a single sign-on credential associated with said user is mapped by said social network server or said information management platform to allow access to said respective virtual partitions of said SHRDB.

7. The system of claim 6, wherein said single sign-on scheme corresponding to said user includes a first credential associated with a first social networking platform, a second credential associated with a second social networking platform, and a third credential associated with a third social networking platform, wherein said user is allowed to access said one or more of said virtual partitions-based repositories using one of said first credential, second credential, and third credential from any of said first social networking platform, second networking platform, and said third networking platform or directly from a dedicated interface corresponding to said one or more virtual partitions.

8. The system of claim 6, further comprising a virtual layer deployed to allocate storage resources across said virtual partitions of said plurality of repositories for storage of said medical records corresponding to said user.

9. The system of claim 1, further comprising a qualification unit operatively coupled to said SHRDB, database server and said social network server to allow said social network server and database server to provide access to said SHRDB by said one or more users based on stored details and defined policies.

10. The system of claim 1, wherein said sign-on scheme is configured as a multi-domain single sign-on scheme such that a user credential associated with any of a plurality of distinct-web domain based social networking platform enables access to said SHRDB.

11. The system of claim 1, wherein said social networking platform includes a web interface including a tab such that said single sign-on scheme is triggered by activating an application through said tab manually by a user or automatically upon accessing said social networking platform.

12. A method for accessing a Social Health Record Data Bank (SHRDB) using a social networking platform, said method comprising:
receiving a request from a user for accessing said SHRDB through a social networking platform;
authenticating a single sign-on credential of said user associated with said social networking platform;
retrieving medical records from said SHRDB as requested by said user, wherein retrieving of said medical records include at least one of sharing of said medical records either partially or fully to said user and allowing viewing of said medical records at least partially by said user.

13. The method of claim 12, wherein said social networking platform is a first social networking platform, and said credential is a first credential associated with said first social networking platform, said method further comprises:
receiving a second request from said user for accessing said SHRDB using a second credential such that at least one combination of:
said first credential and said second credential, and said first social networking platform and said second social networking platform are different.

14. The method of claim 13, wherein said single sign-on credential allows access of said SHRDB by said user automatically upon accessing either of said first social networking platform using said first credential or said second social networking platform using said second credential.

15. A program storage device readable by computer, and comprising a program of instructions executable by said computer to perform a method for accessing a social health record data bank (SHRDB) by a user, said method comprising:
receiving a request from a user for accessing said SHRDB through a social networking platform;
authenticating a single sign-on credential of said user associated with said social networking platform;
retrieving medical records from said SHRDB as requested by said user, wherein retrieving of said medical records include at least one of sharing of said medical records either partially or fully to said user and allowing viewing of said medical records at least partially by said user.

16. The program storage device of claim 15, wherein said social networking platform is a first social networking platform, and said credential is a first credential associated with said first social networking platform, said method further comprising:
receiving a second request from said user for accessing said SHRDB using a second credential such that at least one combination of:
said first credential and said second credential, and said first social networking platform and said second social networking platform are different.

17. The program storage device of claim 16, wherein said single sign-on scheme allows access of said SHRDB by said user automatically upon accessing either of said first social networking platform using said first credential or said second social networking platform using said second credential.
